(19) United States
(12) Patent Application Publication
(10) Pub. No.: US 2008/0157712 A1
(43) Pub. Date: Jul. 3, 2008

(54) Holder and battery charger system for portable electronic device

(76) Inventor: Vicente Garcia, Montreal (CA)

Correspondence Address: INVENTARIUM, SUITE 1607, 4050 ROSEMONT, MONTREAL, QC, H1X1M4, omitted

(21) Appl. No.: 11/947,253

(22) Filed: Nov. 29, 2007

Related U.S. Application Data
(60) Provisional application No. 60/877,241, filed on Dec. 27, 2006.

(51) Int. Cl. H02J 7/00; H02J 7/02; H02J 7/14

(52) U.S. Cl. 320/101; 320/111; 320/115; 320/103

(57) ABSTRACT

A holder and battery charger system for portable electronic devices comprises a back panel and a releasably detachable front panel. The back panel itself comprised of a plurality of integrated sources of power for charging a device. Amongst the plurality of integrated sources of power for charging a device are:

a flip out AC plug.
a slide out USB connector sliding out from within the back panel.
a car plug and a car plug sheath attached to the side of the back panel.
a hand cranked dynamo and a dynamo holder that is attached to the side of the back panel.
An interface connector electrically connects the universal holder and charger to the portable device.
a belt clip connector with a releasably attached belt clip.
a 9 volt battery snap connector.

This application claims priority based on provisional 60/877,241 filed Dec. 27, 2006

### FIELD OF THE INVENTION

The present invention relates generally to a holder and battery charger system for a portable electronic device such as a cellular telephone, PDA, GPS, hand held PC, digital camera or the like.

### BACKGROUND OF THE INVENTION

There are several known ways to recharge a cellular phone battery and even though these means of recharging a cellular phone battery exist, one often ends up with a discharged battery at the time it is needed to make or receive a call. Thus, there is a need for a portable electronic device charger that uses different means for charging, depending on the resources available and the location of the person using the portable electronic device.

Although there is a wide array of holders for portable devices, these holders are generally, at their simplest, a belt clip mechanically attached to the portable device or a pocket of some kind with an attachment means to a belt or a piece of clothing. Some protective holders are similar to protective dust sleeves (for books) but used for flip phones. Some protective cases have zippers or other means to securedly enclosed the portable devices. As far as is known, there are no such holders, clips, sleeves, cases that have integrated any form of emergency power supply such as those to be discussed in herein.

Although there are evidence of electrically powered devices such as flashlights and radios that make use alternate means of generating electricity such as hand cranked dynamos or passive solar captors and although such alternate means could also be used for other devices such as cellular phones, PDAs, MP3 players and related electronic gadgetries, this does not constitute an integration into a holder, clip, sleeves, or case.

### SUMMARY OF THE INVENTION

In view of the foregoing disadvantages inherent in the known apparatus now present in the prior art, the present invention, which will be described subsequently in greater detail, is to provide objects and advantages which are:

To have a holder and charger system that provides the features and benefits of having a plurality of charging system that makes it versatile. Although the individual elements are already available and that there are hundreds of millions of cellular phone users worldwide who have problems with cell phones that have low or no battery charge left and although this problem is felt by the large user base, there does not appear to be a simple and practical solution to that problem. That is until now.

To attain these unobvious ends, the present invention generally comprises a back panel and a releasably detachable front panel. The back panel itself comprised of a plurality of integrated sources of power for charging a device.

Amongst the plurality of integrated sources of power for charging a device are:

a flip out AC plug.
a slide out USB connector sliding out from within the back panel.
a car plug and a car plug sheath attached to the side of the back panel.
a hand cranked dynamo and a dynamo holder that is attached to the side of the back panel.
an interface connector electrically connects the universal holder and charger to the portable device.
a belt clip connector with a releasably attached belt clip.
a 9 volt battery snap connector.

Also, footings cooperating with the front panel and the rear panel to hold the portable device within. The front panel having a solar cell facing and a wire bringing electrical power into the rear panel, and the snap-on changeable front panel is releasably attached to the rear panel by way of snap-on buttons.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Moreover, the term “portable device” refers to any of a variety of electronic devices currently on the market as well as all other similar portable devices yet to be invented. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1 a-e Rear, top, bottom and sides views, respectively, of the invention.

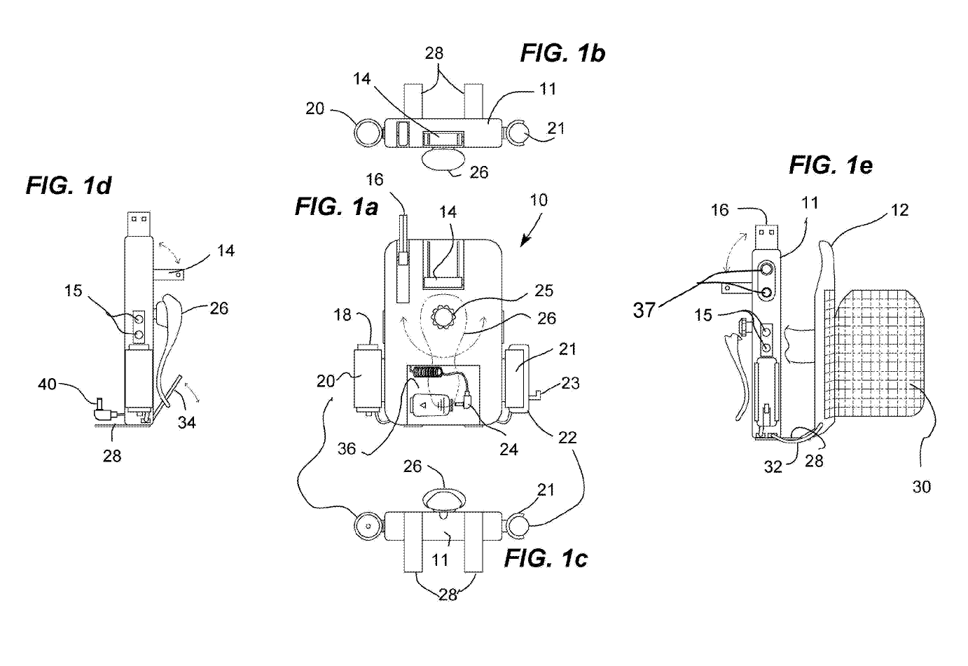

FIGS. 2 a-b Front views showing the solar panel closed and open, respectively.

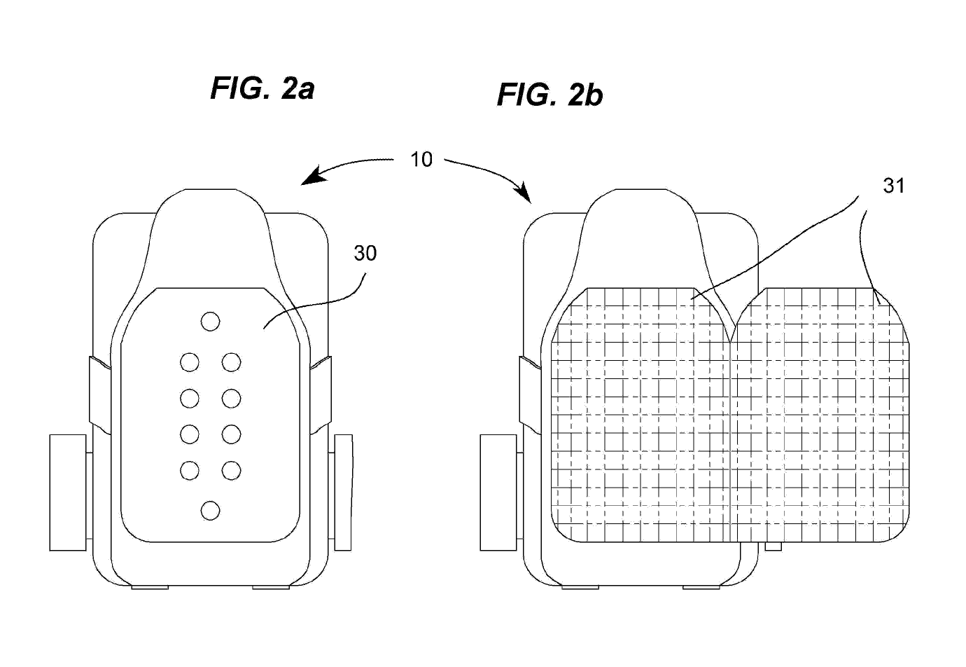

### DETAILED DESCRIPTION

A universal holder and charger (10) with various integrated sources of power for emergency charging has a snap-on changeable front panel (12) with different colors and designs, when used in conjunction with the back panel (11), creates the universal holder and charger (10). The snap-on changeable front panel (12) is releasably attached to the rear panel (11) by way of snap-on buttons (15)

The universal holder and charger (10) has a flip out AC plug (14); a slide out USB connector (16); a car plug (18) and a car plug sheath (20) attached to the side of the back panel (11); a dynamo (22); an interface connector (40) to electrically connect the universal holder and charger (10) to the portable device (24) itself; a belt clip connector (25) with a belt clip (26) releasably attached to it; and a 9 volt battery snap connector (37).

The dynamo (22) has a hand crank (23) and a dynamo holder (21) attached to the back panel (11).

The cell phone is held in place by way of the front panel (12), the rear panel (11) and footings (28).

The front panel (12) can be made of a solar cell (30) with a wire (32) bringing the electrical power into the rear panel (11). In order to increase solar power reception, the solar cell (30) can unfold into a plurality of panels (31). A removable panel (34) closes a connector housing (36).

With the various components described hereinabove, it is clear that there are many ways in which the portable device (24) can be charged. For example, a user can easily get a readily available 9 volt battery from a store and plug it into the 9 volt battery snap connector (37) in order to feed power into the portable device (24). All the power generating means transfer their power from the back panel (11) to the portable device (24) by way of the interface connector (40).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A universal holder and charger for electrically powered portable devices comprising:
a back panel and a releasably detachable front panel;
the back panel comprised of a plurality of integrated sources of power for charging a device.

2. A universal holder and charger for electrically powered devices as in claim 1 wherein:
the plurality of integrated sources of power for charging a device consisting of a flip out AC plug.

3. A universal holder and charger for electrically powered devices as in claim 1 wherein:
a slide out USB connector sliding out from within the back panel.

4. A universal holder and charger for electrically powered devices as in claim 1 wherein:
a car plug and a car plug sheath attached to the side of the back panel.

5. A universal holder and charger for electrically powered devices as in claim 1 wherein:
a hand cranked dynamo and a dynamo holder that is attached to the side of the back panel.

6. A universal holder and charger for electrically powered devices as in claim 1 wherein:
an interface connector electrically connects the universal holder and charger to the portable device.

7. A universal holder and charger for electrically powered devices as in claim 1 wherein:
a belt clip connector with a releasably attached belt clip.

8. A universal holder and charger for electrically powered devices as in claim 1 wherein:
a 9 volt battery snap connector.

9. A universal holder and charger for electrically powered devices as in claim 1 wherein:
footings cooperating with the front panel and the rear panel to hold the portable device within.

10. A universal holder and charger for electrically powered devices as in claim 1 wherein:
the front panel having a solar cell facing and a wire bringing electrical power into the rear panel.

11. A universal holder and charger for electrically powered devices as in claim 1 wherein:
the snap-on changeable front panel is releasably attached to the rear panel by way of snap-on buttons.
